(19) United States
(12) Patent Application Publication
(10) Pub. No.: US 2022/0119593 A1
(43) Pub. Date: Apr. 21, 2022

(54) MULTI-COMPONENT CROSSLINKABLE MASSES BASED ON ORGANYLOXYSILANE-TERMINATED POLYMERS

(71) Applicant: WACKER CHEMIE AG, Munich (DE)

(72) Inventors: Volker STANJEK, Ampfing (DE); Lars ZANDER, Altötting (DE)

(73) Assignee: WACKER CHEMIE AG, Munich (DE)

(21) Appl. No.: 17/428,268

(22) PCT Filed: Feb. 14, 2019
(86) PCT No.: PCT/EP2019/053709

§ 371 Date: Aug. 3, 2021

(51) Int. Cl. C08G 65/336; C08G 65/08; C08K 3/22; C08J 3/24

(52) U.S. Cl. CPC C08G 65/336; C08G 65/08; C08K 3/22; C08G 2170/00; C08K 2003/2227; C08K 2003/2296; C08G 2150/00; C08J 3/24

(57) ABSTRACT

A multi-component crosslinkable composition includes at least one component (K1) and one component (K2). Component (K1) contains organosilicon compounds (A1) selected from compounds (A1a) of formula (Ia), the formula (Ia) being Y¹—[B¹—CR²₂—SiRₐ(OR¹)₃₋ₐ]ₓ, and compounds (A1b) of formula (Ib), the formula (Ib) being Y²—[B²—(CR⁴₂)_{b}—Si(OR³)₃]_{y}. Component (K2), based in each case on 100 parts by weight of compounds (A1) in component (K1), includes at least 0.05 parts by weight of water and 10 to 1000 parts by weight of a component (A2) selected from compounds (A2a) of formula (IIa), the formula (IIa) being Y³—B³—CR⁷₂—SiR⁵_{c}(OR⁶)_{3-c}, and compounds (A2b) of formula (IIb), the formula (IIb) being Y⁴—[B⁴—(CR¹⁰₂)ₑ—SiR⁸_{d}(OR⁹)_{3-d}]_{z}.

The invention relates to multicomponent crosslinkable compositions based on silane-crosslinking polymers, to methods for producing them, and to the use thereof as adhesives and sealants.

Polymer systems possessing reactive alkoxysilyl groups are well-established. On contact with water and/or atmospheric humidity, these alkoxysilane-terminated polymers are able to condense with each other even at room temperature, with elimination of the alkoxy groups. One of the most important applications of such materials is in the production of adhesives and sealants, especially of elastic adhesive systems.

The reason is that adhesives based on alkoxysilane-crosslinking polymers exhibit very good properties in the fully cured state not only of adhesion to any of a very wide variety of substrates, but also of mechanics, since they are able to combine tensile strength with high elasticity. A further decisive advantage of silane-crosslinking systems over numerous other adhesive and sealant technologies (over isocyanate-based or epoxy-based systems, for example) is that they are toxicologically unobjectionable.

Many applications in this realm prefer one-component systems (1K systems) which cure only through contact with the atmospheric moisture. Foremost among the decisive advantages of 1K systems is their easy applicability, since in this case there is no need for the user to mix different adhesive components. As well as the work saved and the avoidance of possible errors in metering or mixing otherwise, there is also no need with one-component systems to process the adhesive or sealant within a usually quite narrow time window, as is the case for two-component systems (2K systems) after the two components have been thoroughly mixed.

However, 1K systems possess the decisive disadvantage, inherent to the system, of curing only on contact with (atmospheric) moisture. In the case of deep joints and/or extensive bonds, this leads to extremely slow curing from “outside to inside”, which because of the increasingly long diffusion pathways proceeds more slowly as the curing progresses. This is especially true when bonding nonporous substrates (plastics, metals, paint or varnish surfaces, glass, and glazed surfaces, etc.), for which this problem cannot be solved by prior uniform moistening of the bonding area either. In the case of such jointing and bonding operations, therefore, the use of 2K systems is advantageous or often, indeed, simply unavoidable.

2K adhesive systems based on silane-crosslinking polymers are already known, having been described in EP-A 824 574 or EP-A 2 448 976, for example. Typical 2K systems here include a 1st component, which comprises the silane-terminated polymer and also further adhesive components such as plasticizers, fillers, catalysts, stabilizers, etc. The 2nd component then accommodates water and also further compounds unreactive with water, such as fillers or plasticizers, and also, optionally, thickening agents, such as cellulose derivatives, for example, and also further components.

These prior-art systems, however, confront the skilled person with the problem that extremely small amounts of water in the 2nd component are sufficient to cause the polymer in the 1st component to cure after the two components have been thoroughly mixed. Moreover, because of the poor mutual solubility of silane-terminated polymer and water, the 2nd component is also unable in this case to contain any substantially greater—additional—amounts of water. A 2nd component containing water as sole liquid would therefore either be solid (e.g., if large amounts of filler were added), although under real-life application conditions this would be hardly practicable, or else the 2nd component should be added to the 1st component on application only in extremely small amounts (e.g., in a mixing ratio of 1:100), something which would be equally impracticable.

Accordingly, besides the water, the 2nd component must also comprise a second, liquid substance unreactive with water. Only unreactive plasticizers, however, are generally appropriate for this purpose. Plasticizer-free 2K systems are therefore not possible with this technology.

Unreactive plasticizers, however, are not incorporated into the resultant polymer network. They may therefore exude, migrate into substrates or else volatilize as gases if the molecules are relatively small. All of this results usually in unwanted changes to properties, such as shrinking and/or embrittlement of the respective adhesive or sealant. Moreover, the migration of plasticizer into the substrate may also lead to unattractive discoloration of this substrate, a phenomenon which is absolutely unacceptable particularly in the case of decorative substrates, made from natural stone, for example. The lack of an option to develop plasticizer-free 2K systems is therefore a critical disadvantage in many cases.

There are indeed 2K systems possible which, although not plasticizer-free, at least contain only small amounts of plasticizer, and so minimize the problems associated with the addition of plasticizer. Yet even systems of this kind confront the developer with a serious problem: if the plasticizer is only to be used in small amounts, then the 2nd water- and plasticizer-containing component can contain only these small amounts of plasticizer and can therefore possess only a small volume. Accordingly, this 2nd component must continue to be admixed to the 1st component, at application, only in comparatively small amounts, such as in a proportion of 1:10 (cf. examples from EP-A 824 574 or example 2 from EP-A 2 448 976). While this is practical in principle, the attainment of even only halfway-exact mixing accuracy is not easy for the user and is therefore inconvenient. Moreover, a system of this kind is very susceptible to mixing errors.

Easier to process and less prone to errors are 2K systems in which the two components are mixed in a 1:1 ratio. But as already observed, using conventional 2K technologies, this is nevertheless possible only when the entire 2K system contains relatively large amounts of plasticizer (cf. example 1 from EP-A 2 448 976), in many cases, however, this is undesirable.

Substantially more favorable here are 2K systems which contain moisture-crosslinking polymers in both components and are therefore no longer tied to a plasticizer in the 2nd component. Examples of such systems are described in EP-A 1 743 008 or EP-A 2 009 063.

The concept on which this technology is based is that the silane-crosslinkable polymers used are so slow to react that they do not crosslink without catalyst even in the presence of water. The polymers can therefore be present in both components, with the 1st component additionally containing a curing catalyst, and the 2nd component containing water.

A disadvantage with this technology, however, is the fact that it can be practiced only using silane-terminated polymers which are very slow to react, which remain uncrosslinked for months in the 2nd component even in the presence of water, and which do not lead to any significant and naturally unwanted increases in viscosity, let alone to any gel. This slowness of reaction on the part of the polymers to be used has the consequence, of course, that the crosslinking desired in the ultimate application can only take place with any rapidity in the presence of comparatively large amounts of decidedly active catalysts. In other words, these systems are required in general to include large amounts of toxicologically objectionable tin catalysts in the first component. Highly reactive, rapidly curing, and tin-free or at least low-tin 2K systems are not producible using this technology.

A further disadvantage of aggressive (tin) catalysis, of the kind unavoidable in such 2K systems, results from the adverse affects of the relevant catalysts on the storage stability of the relevant compositions. Indeed, highly reactive catalysts may catalyze degradation reactions of the silane-terminated polymers and/or other formulation constituents. Typical such degradation reactions include the elimination of the urethane and/or urea units in the polymer backbone, which occurs with silane-terminated polyurethanes, and also the—albeit usually slower—scission of the ether bonds contained in the polymers and also of the ester bonds that may likewise be present.

The same degradation reactions accelerated by aggressive catalysts also have adverse effects on the heat stability of the corresponding adhesives or sealants.

The object was to provide two-component adhesives or sealants, based on silane-terminated polymers, that allow the disadvantages of the prior art to be overcome.

A subject of the invention are multicomponently crosslinkable compositions (K) comprising at least one component (K1) and one component (K2), characterized in that component (K1) comprises organosilicon compounds (A1) selected from compounds (A1a) of the formula (Ia)

Y¹—[B¹—CR²₂—SiRₐ(OR¹)₃₋ₐ]ₓ (Ia)

and compounds (A1b) of the formula (Ib)

Y²—[B²—(CR⁴₂)_{b}—Si(OR³)₃]_{y} (Ib)

where
Y¹ is an x-valent polymer radical bonded via carbon,
Y² is a y-valent polymer radical bonded via carbon,
B¹ and B² each independently of one another may be identical or different and are a divalent linking group —O—, —NH—, —NR′—, —O—CO—NH—, —NH—CO—O—, —NH—CO—NH, —NH—CO—NR′—, —NR′—CO—NH—, —NH—CO—, —CO—NH—, —CO—O—, —O—CO—, —O—CO—O—, —S—CO—NH—, —NH—CO—S—, —CO—S—, —S—CO— or —S—,
R′ may be identical or different and is a monovalent, optionally substituted hydrocarbon radical or a group —CH(COOR*)—CH₂—COOR*, where R* is an alkyl radical,
R may be identical or different and is a monovalent, optionally substituted, SiC-bonded hydrocarbon radical,
R¹ and R³ each independently of one another may be identical or different and are the hydrogen atom or a monovalent, optionally substituted hydrocarbon radical,
R² and R⁴ each independently of one another may be identical or different and are the hydrogen atom or a monovalent, optionally substituted hydrocarbon radical which may be attached to the carbon atom via nitrogen, phosphorus, oxygen, sulfur or carbonyl group,
x and y each independently of one another are an integer from 1 to 10, preferably 1, 2 or 3, more preferably 2 or 3, more particularly 2,
a may be identical or different and is 0, 1 or 2, preferably 0 or 1, with the proviso that if x=1 a=0,
b may be identical or different and is an integer from 3 to 10, preferably 3 or 4, more preferably 3,
   and component (K2), based in each case on 100 parts by weight of compounds (A1) in component (K1), comprises at least 0.05 part by weight of water and also 10 to 1000 parts by weight of a component (A2) selected from compounds (A2a) of the formula (IIa)

Y³—B³—CR⁷₂—SiR⁵_{c}(OR⁶)_{3-c} (IIa)

and compounds (A2b) of the formula (11b)

Y⁴—[B⁴—(CR¹⁰₂)ₑ—SiR⁸_{d}(OR⁹)_{3-d}]_{z} (IIb)

where
Y³ is a monovalent polymer radical bonded via carbon,
Y⁴ is a z-valent polymer radical bonded via carbon,
B³ and B⁴ in each case independently of one another may be identical or different and are a divalent linking group —O—, —NH—, —NR″—, —O—CO—NH—, —NH—CO—O—, —NH—CO—NH, —NH—CO—NR″—, —NR″—CO—NH—, —NH—CO—, —CO—NH—, —CO—O—, —O—CO—, —O—CO—O—, —S—CO—NH—, —NH—CO—S—, —CO—S—, —S—CO— or —S—,
R″ may be identical or different and is a monovalent, optionally substituted hydrocarbon radical or a group —CH(COOR*)—CH₂—COOR*, where R* is an alkyl radical,
R⁵ and R⁸ each independently of one another may be identical or different and are a monovalent, optionally substituted, SiC-bonded hydrocarbon radical,
R⁶ and R⁹ each independently of one another may be identical or different and are the hydrogen atom or a monovalent, optionally substituted hydrocarbon radical,
R⁷ and R¹⁰ each independently of one another may be identical or different and are the hydrogen atom or a monovalent, optionally substituted hydrocarbon radical which may be attached to the carbon atom via nitrogen, phosphorus, oxygen, sulfur or carbonyl group,
z is an integer from 1 to 10, preferably 1, 2 or 3, more preferably 2 or 3, more particularly 2,
c is 1 or 2, preferably 1,
d may be identical or different and is 1 or 2, preferably 1, and
e may be identical or different and is an integer from 3 to 10, preferably 3 or 4, more preferably 3.

The compositions (K) of the invention are preferably two-component compositions which consist of components (K1) and (K2).

Components (K1) and (K2) of the compositions (K) of the invention are preferably kept separately during storage and not mixed with one another until shortly before or else during the application of the composition (K) of the invention. Preferably components (K1) and (K2) are mixed with one another not more than 60 min, more preferably not more than 30 min, more particularly not more than 10 min before the application. Mixing of the components (K1) and (K2) only during the application also constitutes an especially preferred embodiment of the invention.

Examples of radicals R are alkyl radicals, such as the methyl, ethyl, n-propyl, isopropyl, 1-n-butyl, 2-n-butyl, isobutyl, tert-butyl, n-pentyl, isopentyl, neopentyl, tert-pentyl radical; hexyl radicals, such as the n-hexyl radical; heptyl radicals, such as the n-heptyl radical; octyl radicals, such as the n-octyl radical, isooctyl radicals and the 2,2,4-trimethylpentyl radical; nonyl radicals, such as the n-nonyl radical; decyl radicals, such as the n-decyl radical; dodecyl radicals, such as the n-dodecyl radical; octadecyl radicals, such as the n-octadecyl radical, cycloalkyl radicals, such as the cyclopentyl, cyclohexyl, cycloheptyl radical and methylcyclohexyl radicals; alkenyl radicals, such as the vinyl, 1-propenyl and the 2-propenyl radical; aryl radicals, such as the phenyl, naphthyl, anthryl and phenanthryl radical; alkaryl radicals, such as o-, m- and p-tolyl radicals; xylyl radicals and ethylphenyl radicals; and aralkyl radicals, such as the benzyl radical, the α- and the β-phenylethyl radical.

Examples of substituted radicals R are haloalkyl radicals and haloaryl radicals, such as the o-, m- and p-chlorophenyl radical.

Examples of radicals R⁵ and R⁸ are the examples specified above for radical R.

In each case independently of one another, the radicals R, R⁵ and R⁸ are preferably monovalent, SiC-bonded hydrocarbon radicals having 1 to 6 carbon atoms and being optionally substituted by halogen atoms, and more preferably are alkyl radicals having 1 or 2 carbon atoms, and more particularly are methyl radicals.

Examples of radicals R¹, R³, R⁶ and R⁹ are the hydrogen atom and the examples specified for the radicals R.

In each case independently of one another, the radicals R¹, R³, R⁶ and R⁹ are preferably the hydrogen atom or alkyl radicals having 1 to 10 carbon atoms and being optionally substituted by halogen atoms, and more preferably are alkyl radicals having 1 to 4 carbon atoms, and more particularly are methyl or ethyl radicals.

With particular preference all of the radicals R¹, R³, R⁶ and R⁹ are methyl radicals.

Examples of radicals R², R⁴, R⁷ and R¹⁰ are the hydrogen atom, the radicals specified for radical R, and also optionally substituted hydrocarbon radicals bonded to the carbon atom via nitrogen, phosphorus, oxygen, sulfur, carbon or carbonyl group.

In each case independently of one another, the radicals R², R⁴, R⁷ and R¹⁰ are preferably the hydrogen atom or hydrocarbon radicals having 1 to 20 carbon atoms, more particularly the hydrogen atom.

The linking groups B¹ and B² independently of one another are preferably —O—, —NH—, —NR′—, —O—CO—NH—, —NH—CO—O—, —NH—CO—NH, —NH—CO—NR′— or —NR′—CO—NH—, more preference being given to linking groups —O—, —O—CO—NH—, —NH—CO—O—, —NH—CO—NR′— or —NR′—CO—NH— and particular preference to —O— or —O—CO—NH—, more particularly to —O—CO—NH—.

The linking groups B³ and B⁴ independently of one another are preferably —O—, —NH—, —NR″—, —O—CO—NH—, —NH—CO—O—, —NH—CO—NH, —NH—CO—NR″— or —NR″—CO—NH—, more preference being given to linking groups —O—, —O—CO—NH—, —NH—CO—O—, —NH—CO—NR″— or —NR″—CO—NH— and particular preference to —O— or —O—CO—NH—, more particularly —O—CO—NH—.

Examples of radicals R′ and R″ are cyclohexyl, cyclopentyl, n- and isopropyl, n-, iso- and tert-butyl radicals, the various sterioisomers of the pentyl radical, the hexyl radical or the heptyl radical, phenyl radicals or radicals of the formula —CH(COOR*)—CH₂—COOR*, where R* is an alkyl radical.

Independently of one another the radicals R′ and R″ are preferably a group —CH(COOR*)—CH₂—COOR* or an optionally substituted hydrocarbon radical having 1 to 20 carbon atoms, more preferably a linear, branched or cyclic alkyl group having 1 to 20 carbon atoms, or an aryl group having 6 to 20 carbon atoms which is optionally substituted by halogen atoms.

The radicals R* are preferably alkyl groups having 1 to 10 carbon atoms, more preferably methyl, ethyl or propyl radicals.

The polymer radicals Y¹, Y², Y³ and Y⁴ independently of one another are preferably organic polymer radicals wherein the polymer chain comprises polyoxyalkylenes, such as polyoxyethylene, polyoxypropylene, polyoxybutylene, polyoxytetramethylene, polyoxyethylene-polyoxypropylene copolymer and polyoxypropylene-polyoxybutylene copolymer; hydrocarbon polymers, such as polyisobutylene, polyethylene or polypropylene and copolymers of polyisobutylene with isoprene; polyisoprenes; polyurethanes; polyesters; polyamides; polyacrylates; polymetacrylates; or polycarbonates.

Preferably, independently of one another, the polymer radicals Y¹, Y², Y² and Y⁴ have no groups that are reactive with water or moisture. In particular, independently of one another, they have no groups that are reactive with water or moisture and no silicon-containing groups, in particular no alkoxysilyl groups.

In each case independently of one another, the polymer radicals Y¹, Y², Y³ and Y⁴ are more preferably polyurethane radicals and polyoxyalkylene radicals, more particularly polyoxypropylene-containing polyurethane radicals or polyoxypropylene radicals.

Where Y¹, Y², Y³ and/or Y⁴ are polyurethane radicals, they are independently of one another preparable preferably from linear or branched polyoxyalkylenes, more particularly from polypropylene glycols, and from di- or polyisocyanates.

Where Y¹, Y², Y³ and/or Y⁴ are polyoxyalkylene radicals, the radicals in question independently of one another are preferably linear or branched polyoxyalkylene radicals, more preferably polyoxypropylene radicals.

The polyoxyalkylene radicals Y¹, Y², Y³ and Y⁴ independently of one another preferably have number-average molar masses Mₙ of 10 000 to 30 000 g/mol, more preferably of 11 000 to 20 000 g/mol.

The number-average molar mass Mₙ here is determinable by size exclusion chromatography (SEC) against polystyrene standards, in THF, at 60° C., flow rate 1.2 ml/min and detection by RI (refractive index detector) on a Styragel HR3-HR4-HR5-HR5 column set from Waters Corp. USA with an injection volume of 100 μl.

Independently of one another, the compounds (A1a), (A1b), (A2a) and (A2b) used in the invention may have the alkoxysilane-functional groups at any locations in the polymer, such as, for instance, within the chain and/or terminally, preferably terminally.

Preferably, independently of one another, the compounds (A1a), (A1b), (A2a) and (A2b) are silane-terminated polyoxyalkylenes, more preferably silane-terminated polyoxypropylenes of the formulae (Ia), (Ib), (IIa) and (IIb), respectively, where R, R⁵ and R⁸ are methyl radicals, R¹, R³, R⁶ and R⁹ are methyl or ethyl radicals, more particularly methyl radicals, R², R⁴, R⁷ and R¹⁰ are the hydrogen atom, B¹, B², B³ and B⁴ are —O— or —O—CO—NH—, more particularly —O—CO—NH—, a is 0 or 1, b is 3, c is 1 and d is 1. The silane-terminated polyoxyalkylenes contain preferably exclusively polyether units apart from the silane-functional ends groups represented in the formulae.

The polymers (A1a), (A1b) and (A2b) used in the invention preferably possess 2 or 3, more preferably 2, silane-functional end groups per molecule. The polymers (A2a) of the invention possess exactly one silane-functional end group.

Silane-terminated polyoxyalkylenes (A1a), (A1b), (A2a) and (A2b) in which B¹, B², B³ and B⁴ are —O—CO—NH— can be prepared in a simple way by reaction of common polyoxyalkylenes, terminated by hydroxyl groups, and silanes of the formulae

OCN—CR²₂—SiRₐ(OR¹)₃₋ₐ (IIIa),

OCN—(CR⁴₂)_{b}—Si(OR³)₃ (IIIb),

OCN—CR⁷₂—SiR⁵_{c}(OR⁶)_{3-c} (III′a) and

OCN—(CR¹⁰₂)ₑ—SiR⁸_{d}(OR⁹)_{3-d} (III′b)

respectively, where all of the radicals and indices have one of the definitions stated above.

Another common method for producing the compounds of the formulae (Ib) and/or (IIb) provides for hydrosilylation of terminally unsaturated polyoxyalkylenes with corresponding SiH-functional silanes.

The number-average molecular weights Mₙ of the compounds (A1a), (A1b), (A2a) and (A2b) independently of one another are preferably 10 000 g/mol to 30 000 g/mol, more preferably 11 000 g/mol to 24 000 g/mol, more particularly 11 000 g/mol to 22 000 g/mol.

The viscosity of the compounds (A1a), (A1b), (A2a) and (A2b) used in the invention, independently of one another, is preferably 0.2 Pas to 700 Pas, more preferably 1 Pas to 100 Pas, very preferably 5 Pas to 100 Pas, measured in each case at 20° C.

The compounds (A1a), (A1b), (A2a) and (A2b) used in the invention may each represent only one kind of compound of the formulae (Ia), (Ib), (IIa) or (IIb), respectively, or else mixtures of different kinds of the compounds in question.

The compounds (A1a), (A1b), (A2a) and (A2b) used in the invention are standard commercial products or may be produced by methods common within chemistry.

The organosilicon compounds (A1) used in the invention may comprise only compounds (A1a) or only compounds (A1b), or mixtures of compounds (A1a) with compounds (A1b), and are preferably compounds (A1a) or mixtures of compounds (A1a) and (A1b), and more preferably are compounds (A1a). Where organosilicon compounds (A1) comprise mixtures of compounds (A1a) with (A1b), the mixing ratio of compounds (A1a) to compounds (A1b) is preferably 0.1 to 10, more preferably 0.2 to 5, based in each case on the weight.

The organosilicon compounds (A2) used in the invention may comprise only compounds (A2a) or only compounds (A2b), or mixtures of compounds (A2a) with compounds (A2b), and the compounds (A2) preferably comprise exclusively compounds (A2a) or exclusively compounds (A2b).

Preferably at least one of the components, (K1) or (K2), comprises polymers possessing what are called □-silyl groups, for which the silane-crosslinking group is separated from the linking group only by a methylene spacer. In other words, component (A1) preferably comprises compounds (A1a), and/or component (A2) comprises compounds (A2a).

In one particularly preferred embodiment of the invention, component (A1) comprises compounds (A1a) and component (A2) comprises compounds (A2b), and more particularly organosilicon compound (A1) consists of compounds (A1a), and organosilicon compound (A2) consists of compounds (A2b).

Component (K2) contains preferably 20 to 500 parts by weight, more preferably 50 to 200 parts by weight, of organosilicon compounds (A2), based in each case on 100 parts by weight of organosilicon compounds (A1) in component (K1).

Component (K2) preferably comprises 0.1 to 10 parts by weight, more preferably 0.2 to 5 parts by weight, more particularly 0.4 to 3 parts by weight of water, based in each case on 100 parts by weight of organosilicon compounds (A1) in component (K1).

In another preferred embodiment, component (K1) comprises not only compounds (A1), preferably (A1a), but also compound (A2a). If component (K1) comprises compound (A2a), the amounts involved are preferably 1 to 100 parts by weight, more preferably 5 to 50 parts by weight, more particularly 10 to 30 parts by weight of compound (A2a), based in each case on 100 parts by weight of organosilicon compounds (A1) in component (K1). The use of compounds (A2a) and/or (A2b) in component (K2) in accordance with the invention is unaffected by this additional use of the compound (A2a) in component (K1).

The water used in the invention may be present directly as such, in the form of aqueous preparations, or as water contained in solids or absorbed by them.

Examples of aqueous preparations are aqueous emulsions, such as emulsions of water in plasticizer, organic solvent and/or silicone resins, for example. Optionally here there may also be a thickener and/or fillers present.

Examples of water contained in solids is moisture bound to fillers, such as finely divided fillers, for example, such as hydrophilic silicas or ground calcium carbonates, which may contain up to more than 1 wt % of surface-bound water.

Other examples of water contained in solids are fillers, such as precipitated calcium carbonates, zeolites or else optionally activated colloidal magnesium aluminum silicates which contain water bonded physically in the interior of the filler particles, or water particles surrounded by waxy or resinous polymers.

For producing component (K2) in accordance with the invention, water is preferably used directly as such.

Further to the compounds (A1a), (A1b), (A2a) and/or (A2b) and water, the compositions (K) of the invention may comprise any further substances which have also been used to date in crosslinkable compositions and which are different from compounds (A1a), (A1b), (A2a), (A2b) and water, examples being organosilicon compound (B) containing basic nitrogen, fillers (C), silicone resins (D), catalysts (E), adhesion promoters (F), water scavengers (G), thickeners (H), unreactive plasticizers (I), organic solvents (J), additives (L) and adjuvants (M).

The compounds (B) used optionally in the compositions (K) of the invention are preferably organosilicon compounds comprising units of the formula

DₕSi(OR¹¹)_{g}R¹²_{f}O_{(4-f-g-h)/2} (IV),

in which
R¹¹ may be identical or different and denotes the hydrogen atom or optionally substituted hydrocarbon radicals,
D may be identical or different and denotes a monovalent, SiC-bonded radical containing basic nitrogen,
R12 may be identical or different and denotes a monovalent, optionally substituted, SiC-bonded organic radical free of basic nitrogen,
f is 0, 1, 2 or 3, preferably 1 or 0,
g is 0, 1, 2 or 3, preferably 1, 2 or 3, more preferably 2 or 3, and
h is 0, 1, 2, 3 or 4, preferably 1,
   with the proviso that the sum of f+g+h is less than or equal to 4 and there is at least one radical D present per molecule.

The organosilicon compounds (B) used optionally in the invention may be silanes, i.e., compounds with the formula (VI) with f+g+h=4, and siloxanes, i.e., compounds containing units of the formula (IV) with f+g+h≤3, and preferably are silanes.

Examples of optionally substituted hydrocarbon radicals R¹¹ are the examples specified for radical R.

The radicals R¹¹ are preferably the hydrogen atom or hydrocarbon radicals having 1 to 18 carbon atoms and optionally substituted by halogen atoms, more preferably the hydrogen atom or hydrocarbon radicals having 1 to 10 carbon atoms, and more particularly methyl or ethyl radical.

Examples of radical R¹² are the examples specified for R.

Radical R¹² preferably comprises hydrocarbon radicals having 1 to 18 carbon atoms and optionally substituted by halogen atoms, more preferably hydrocarbon radicals having 1 to 5 carbon atoms, and more particularly the methyl radical.

Examples of radicals D are radicals of the formulae H₂N(CH₂)₃—, H₂N(CH₂)₂NH(CH₂)₃—, H₂N(CH₂)₂NH(CH₂)₂NH(CH₂)₃—, H₃CNH(CH₂)₃—, C₂H₅NH(CH₂)₃—, C₃H₇NH(CH₂)₃—, C₄H₉NH(CH₂)₃—, C₅H₁₁NH(CH₂)₃—, C₆H₁₃NH(CH₂)₃, C₇H₁₅NH(CH₂)₃—, H₂N(CH₂)₄—, H₂N—CH₂—CH(CH₃)—CH₂—, H₂N(CH₂)₅—, cyclo-C₅H₉NH(CH₂)₃—, cyclo-C₆H₁₁NH(CH₂)₃—, phenyl-NH(CH₂)₃—, (CH₃)₂N(CH₂)₃—, (C₂H₅)₂N(CH₂)₃—, (C₃H₇)₂NH(CH₂)₃—, (C₄H₉)₂N(CH₂)₃—, (C₅H₁₁)₂N(CH₂)₃—, (C₆H₁₃)₂N(CH₂)₃—, (C₇H₁₅)₂N(CH₂)₃—, H₂N(CH₂)—, H₂N(CH₂)₂NH(CH₂)—, H₂N(CH₂)₂NH(CH₂)₂NH(CH₂)—, H₃CNH(CH₂)—, C₂H₅NH(CH₂)—, C₃H₇NH(CH₂)—, C₄H₉NH(CH₂)—, C₅H₁₁NH(CH₂)—, C₆H₁₃NH(CH₂)—, C₇H₁₅NH(CH₂)—, cyclo-C₅H₉NH(CH₂)—, cyclo-C₆H₁₁NH(CH₂)—, phenyl-NH(CH₂)—, (CH₃)₂N(CH₂)—, (C₂H₅)₂N(CH₂)—, (C₃H₇)₂NH(CH₂)—, (C₄H₉)₂NH(CH₂)—, (C₅H₁₁)₂NH(CH₂)—, (C₆H₁₃)₂NH(CH₂)—, (C₇H₁₅)₂NH(CH₂)—,

(CH₃O)₃Si(CH₂)₃NH(CH₂)₃—, (C₂H₅O)₃Si(CH₂)₃NH(CH₂)₃—,
(CH₃O)₂(CH₃)Si(CH₂)₃NH(CH₂)₃— and (C₂H₅O )₂(CH₃)Si(CH₂)₃NH(CH₂)₃— and also reaction products of the above-stated primary amino groups with compounds containing epoxide groups or double bonds that are reactive toward primary amino groups.

Radical D preferably comprises the H₂N(CH₂)₃—, H₂N(CH₂)₂NH(CH₂)₃—or cyclo-C₆H₁₁NH(CH₂)₃ radical.

Examples of the silanes of the formula (IV) used optionally in the invention are H₂N(CH₂)₃—Si(OCH₃)₃,
H₂N(CH₂)₃—Si(OC₂H₅)₃, H₂N(CH₂)₃—Si(OCH₃)₂CH₃,
H₂N(CH₂)₃—Si(OC₂H₅)₂CH₃, H₂N(CH₂)₂NH(CH₂)₃—Si(OCH₃)₃,
H₂N(CH₂)₂NH(CH₂)₃—Si(OC₂H₅)₃, H₂N(CH₂)₂NH(CH₂)₃—Si(OCH₃)₂CH₃,
H₂N(CH₂)₂NH(CH₂)₃—Si(OC₂H₅)₂CH₃, H₂N(CH₂)₂NH(CH₂)₃—Si(OH)₃,
H₂N(CH₂)₂NH(CH₂)₃—Si(OH)₂CH₃, H₂N(CH₂)₂NH(CH₂)₂NH(CH₂)₃—Si(OCH₃)₃,
H₂N(CH₂)₂NH(CH₂)₂NH(CH₂)₃—Si(OC₂H₅)₃, cyclo-C₆H₁₁NH(CH₂)₃—Si(OCH₃)₃,
cyclo-C₆H₁₁NH(CH₂)₃—Si(OC₂H₅)₃, cyclo-C₆H₁₁NH(CH₂)₃—Si(OCH₃)₂CH₃,
cyclo-C₆H₁₁NH(CH₂)₃—Si(OC₂H₅)₂CH₃, cyclo-C₆H₁₁NH(CH₂)₃—Si(OH)₃,
cyclo-C₆H₁₁NH(CH₂)₃—Si(OH)₂CH₃, phenyl-NH(CH₂)₃—Si(OCH₃)₃, phenyl-NH(CH₂)₃—Si(OC₂H₅)₃, phenyl-NH(CH₂)₃—Si(OCH₃)₂CH₃,
phenyl-NH(CH₂)₃—Si(OC₂H₅)₂CH₃, phenyl-NH(CH₂)₃—Si(OH)₃, phenyl-NH(CH₂)₃—Si(OH)₂CH₃, HN((CH₂)₃—Si(OCH₃)₃)₂,
HN((CH₂)₃—Si(OC₂H₅)₃)₂HN((CH₂)₃—Si(OCH₃)₂CH₃)₂,
HN((CH₂)₃—Si(OC₂H₅)₂CH₃)₂, cyclo-C₆H₁₁NH(CH₂)—Si(OCH₃)₃, cyclo-C₆H₁₁NH(CH₂)—Si(OC₂H₅)₃, cyclo-C₆H₁₁NH(CH₂)—Si(OCH₃)₂CH₃, cyclo-C₆H₁₁NH(CH₂)—Si(OC₂H₅)₂CH₃, cyclo-C₆H₁₁NH(CH₂)—Si(OH)₃, cyclo-C₆H₁₁NH(CH₂)—Si(OH)₂CH₃, phenyl-NH(CH₂)—Si(OCH₃)₃,
phenyl-NH(CH₂)—Si(OC₂H₅)₃, phenyl-NH(CH₂)—Si(OCH₃)₂CH₃, phenyl-NH(CH₂)—Si(OC₂H₅)₂CH₃, phenyl-NH(CH₂)—Si(OH)₃ and
phenyl-NH(CH₂)—Si(OH)₂CH₃ and also the partial hydrolysates thereof, preference being given to H₂N(CH₂)₂NH(CH₂)₃—Si(OCH₃)₃, H₂N(CH₂)₂NH(CH₂)₃—Si(OC₂H₅)₃, H₂N(CH₂)₂NH(CH₂)₃—Si(OCH₃)₂CH₃, cyclo-C₆H₁₁NH(CH₂)₃—Si(OCH₃)₃, cyclo-C₆H₁₁NH(CH₂)₃—Si(OC₂H₅)₃ or cyclo-C₆H₁₁NH(CH₂)₃—Si(OCH₃)₂CH₃ and also in each case the partial hydrolysates thereof, and particular preference being given to H₂N(CH₂)₂NH(CH₂)₃—Si(OCH₃)₃, H₂N(CH₂)₂NH(CH₂)₃—Si(OCH₃)₂CH₃, cyclo-C₆H₁₁NH(CH₂)₃—Si(OCH₃)₃ or cyclo-C₆H₁₁NH(CH₂)₃—Si(OCH₃)₂CH₃ and also in each case their partial hydrolysates.

The organosilicon compounds (B) used optionally in the invention may also take on the function of curing catalyst or curing cocatalyst in the compositions of the invention.

Furthermore, the organosilicon compounds (B) used optionally in the invention may act as adhesion promoters and/or as water scavengers.

The organosilicon compounds (B) used optionally in the invention are standard commercial products or are producible by methods common within chemistry.

If organosilicon compounds (B) containing basic nitrogen are used, they are preferably constituents of component (K1).

If component (K1) comprises compounds (B), the amounts involved are preferably 0.1 to 25 parts by weight, more preferably 0.5 to 10 parts by weight, based in each case on 100 parts by weight of all of the compounds (A1a), (A1b), (A2a) and/or (A2b) used in the mixture (K). Component (K1) of the invention preferably comprises compounds (B).

The fillers (C) used optionally in the compositions (K) of the invention may be any desired fillers known to date.

Examples of (C) are nonreinforcing fillers, these being fillers having a BET surface area of preferably up to 50 m²/g, such as quartz, diatomaceous earth, calcium silicate, zirconium silicate, talc, kaolin, zeolites, metal oxide powders, such as ground and also calcined oxides of aluminum, of titanium, of iron or of zinc and/or mixed oxides thereof. Generally speaking, there are no limits on the morphology—whether sharp-edged through potato-shaped or spherical—since both fractionated and ground grades can be used. The size of these fillers is preferably in a range from 0.01 μm to 100 □□m, more particularly from 0.1 μm to 50 □□m.

Additionally suitable are salts such as barium sulfate, calcium carbonate, gypsum, silicon nitride, silicon carbide, boron nitride, glass powders and plastics powders, such as polyacrylonitrile powder; reinforcing fillers, these being fillers having a BET surface area of more than 50 m²/g, such as fumed silica, precipitated silica, precipitated chalk, carbon black, such as furnace black and acetylene black, and mixed silicon aluminum oxides of high BET surface area; aluminum trihydroxide, aluminosilicates, clay minerals, magnesium aluminum silicates, for instance those obtainable under the tradename Micro-sorb® from BASF, fillers in the form of hollow beads, such as ceramic microbeads, examples being those available under the tradename Zeeospheres™ from 3M Deutschland GmbH of Neuss, Germany, elastic polymeric beads, for instance those available under the tradename EXPANCEL® from AKZO NOBEL, Expancel in Sundsvall, Sweden, or glass beads; fibrous fillers, such as asbestos and also plastics fibers. The stated fillers may have been hydrophobized, by treatment, for example, with organosilanes and/or organosiloxanes or with stearic acid, or by etherification of hydroxyl groups to form alkoxy groups.

The fillers (C) used optionally are preferably calcium carbonate, talc, silica or aluminum trihydroxide.

Employed preferably in component (K2), moreover, are magnesium aluminum silicates, on account of their high absorbency for the water likewise added to this component.

Preferred calcium carbonate grades are ground or precipitated and optionally surface-treated with fatty acids such as stearic acid or salts thereof. Silica, which is preferred, preferably comprises fumed silica.

Fillers (C) used optionally have a moisture content of preferably below 1 wt %, more preferably of below 0.5 wt %.

Fillers (C) here may be a constituent of component (K1) and also a constituent of component (K2). They may also be present in both components (K1) and (K2).

If the compositions (K) of the invention do comprise fillers (C), the amounts involved are preferably 10 to 1000 parts by weight, more preferably 50 to 500 parts by weight, more particularly 80 to 300 parts by weight, based in each case on 100 parts by weight of all of the compounds (A1a), (A1b), (A2a) and/or (A2b) used in the mixture (K). The compositions (K) of the invention preferably do comprise fillers (C).

In one preferred embodiment of the invention, the fillers (C) included in the compositions (K) of the invention comprise a combination of

a) calcium carbonate, aluminum trihydroxide and/or talc with
b) silica, more particularly fumed silica, and/or
c) colloidal magnesium aluminum silicate,
preferably in component (K2).

If the compositions (K) of the invention do comprise this particular combination of different fillers (C), they contain preferably 0 to 80 parts by weight, more preferably 5 to 40 parts by weight, of silica, more particularly fumed silica, and preferably 10 to 500 parts by weight, more preferably 50 to 300 parts by weight, of calcium carbonate, aluminum trihydroxide, talc or mixtures of these materials, 0 to 100, preferably 5 to 40 parts by weight of colloidal magnesium aluminum silicate, based in each case on 100 parts by weight of all the compounds (A1a), (A1b), (A2a) and/or (A2b) used in the mixture (K).

The silicone resins (D) used optionally in the compositions (K) of the invention are preferably phenyl silicone resins.

Examples of silicone resins which can be used as components (D) are standard commercial products, examples being different SILRES® grades from Wacker Chemie AG, such as SILRES® IC 368, SILRES® IC 678, SILRES® IC 232, SILRES® IC 235 or SILRES® SY231.

If the compositions (K) of the invention do comprise resins (D), the amounts involved are preferably 5 to 1000 parts by weight, more preferably 10 to 500 parts by weight, more particularly 50 to 300 parts by weight, based in each case on 100 parts by weight of all of the compounds (A1a), (A1b), (A2a) and/or (A2b) used in the mixture (K).

The total amount of silicone resin (D) in this case may be located entirely in component (K1), entirely in component (K2), or else in each case in portions in both components (K1) and (K2).

The catalysts (E) used optionally in the compositions of the invention may be any desired catalysts known to date for compositions which cure by silane condensation.

Examples of metal-containing curing catalysts (E) are organotitanium and organotin compounds, examples being titanic esters, such as tetrabutyl titanate, tetrapropyl titanate, tetraisopropyl titanate and titanium tetraacetylacetonate; tin compounds, such as dibutyltin dilaurate, dibutyltin maleate, dibutyltin diacetate, dibutyltin dioctanoate, dibutyltin acetylacetonate, dibutyltin oxides, and corresponding dioctyltin compounds.

Examples of metal-free curing catalysts (E) are basic compounds, such as triethylamine, tributylamine, 1,4-diazabicyclo[2.2.2]octane, 1,5-diazabicyclo[4.3.0]non-5-ene, 1,8-diazabicyclo[5.4.0]undec-7-ene, N,N-bis(N,N-dimethyl-2-aminoethyl)methyl amine, N,N-dimethylcyclohexylamine, N,N-dimethylphenylamine and N-ethylmorpholinine, guanindine derivates such as mono-, di-, tri-, tetra- or pentamethylguanidine.

Likewise employable as catalyst (E) are acidic compounds, such as phosphoric acid and its esters, toluenesulfonic acid, sulfuric acid, nitric acid or else organic carboxylic acids, examples being acetic acid and benzoic acid.

If the compositions (K) of the invention do comprise catalysts (E), the catalysts involved are preferably low-tin catalysts, more preferably tin-free catalysts (E), more particularly metal-free catalysts (E).

Catalysts (E) here are used preferably as a constituent of component (K1).

If the compositions (K) of the invention do comprise catalysts (E) the amounts involved are preferably 0.01 to 20 parts by weight, more preferably 0.05 to 5 parts by weight, based in each case on 100 parts by weight of all the compounds (A1a), (A1b), (A2a) and/or (A2b) used in the mixture (K).

If the compositions (K) of the invention do comprise tin catalysts (E), which is not preferred, the amounts involved are such that the weight fraction of tin is preferably at most 500 ppm by weight, more preferably at most 250 ppm by weight, especially preferably at most 100 ppm by weight, based in each case on the total weight of the composition (K).

The polymers (A1a) and (A2a) are notable for very high reactivity with respect to water and therefore in general require only very small amounts of a tin catalyst or even cure under entirely tin-free catalysis, in the presence of amine catalysts, for example, with sufficient rapidity. Surprisingly this low-tin or tin-free curing operates even when these polymers (A1a) and/or (A2a) are mixed with conventional polymers of low reactivity, i.e., polymers (A1b) or (A2b). 2K systems of this kind therefore cure rapidly without tin or with a little tin even when only one of the two components, (K1) or (K2), contains highly reactive polymers (A1a) or (A2a). This is true especially of the aforesaid embodiment of the invention in which component (K1) comprises compounds (A1a) and component (K2) comprises compounds (A2b). To this extent, tin-free compositions (K) which comprise compound (A1a) and/or (A2a) represent a particularly preferred embodiment of the invention.

The adhesion promoters (F) used optionally in the compositions (K) of the invention may be any desired adhesion promoters which have been described to date for systems curing by silane condensation and which are different from the compounds (B).

Examples of adhesion promoters (F) are epoxy silanes, such as glycidyl-oxypropyltrimethoxysilanes, glycidyloxypropyl-methyldimethoxysilane, glycidyloxypropyltriethoxysilane or glycidyloxypropyl-metyhldiethoxysilane, 2-(3-triethoxysilylproypl)maleic anhydride, N-(3-trimethoxysilylpropyl)urea, N-(3-triethoxysilylpropyl)urea, N-(trimethoxysilylmethyl)urea, N-(methyldimethoxysilymethyl)urea, N-(3-triethoxysilylmethyl)urea, N-(3-methyldiethoxysilylmethyl)urea, O-methylcarbamatomethylmethyldimethoxysilane, O-methylcarbamatomethyltrimethoxysilane, O-ethylcarbamatomethylmethyldiethoxysilane, O-ethylcarbamatomethyltriethoxysilane, 3-methacryloxypropyltrimethoxysilane, methacryloxymethyltrimethoxysilane, methacryloxymethylmethyldimethoxysilane, methacryloxymethyltriethoxysilane, methacryloxymethylmethyldiethoxysilane, 3-acryloxypropyltrimethoxysilane, acryloxymethyltrimethoxysilane, acryloxymethylmethyldimethoxysilanes, acryloxymethyltriethoxysilane and acryloxymethylmethyldiethoxysilane and also their partial condensates.

If adhesion promoters (F) are used, they may be included in components (K1) and/or in component (K2).

If the compositions (K) of the invention do comprise adhesion promoters (F), the amounts involved are preferably 0.5 to 30 parts by weight, more preferably 1 to 10 parts by weight, based in each case on 100 parts by weight of all the compounds (A1a), (A1b), (A2a) and/or (A2b) used in the mixture (K).

The water scavengers (G) used optionally in the compositions (K) of the invention may be any desired water scavengers which have been described for systems curing by silane condensation and which are different from the compounds (B) and (F).

Examples of water scavengers (G) are silanes such as vinyltrimethoxysilane, vinyltriethoxysilane, vinylmethyldimethoxysilane, O-methylcarbamatomethylmethyldimethoxysilane, O-methylcarbamatomethyltrimethoxysilane, O-ethylcarbamatomethylmethyldiethoxysilane, O-ethylcarbamatomethyltriethoxysilane, and/or their partial condensates, and also orthoesters, such as 1,1,1-trimethoxyethane, 1,1,1-triethoxyethane, trimethoxymethane and triethoxymethane.

If water scavengers (G) are used, they are preferably constituents of component (K1).

If component (K1) does comprise water scavengers (G), the amounts involved are preferably 0.5 to 30 parts by weight, more preferably 1 to 10 parts by weight, based in each case on 100 parts by weight of all the compounds (A1a), (A1b), (A2a) and/or (A2b) used in the mixture (K). Component (K1) preferably comprises water scavengers (F).

The thickeners (H) used optionally in the compositions (K) of the invention are preferably organic thickeners, more preferably water-soluble or water-swellable polymers. Examples of organic thickeners (H) are starch, dextrins, oligosaccharides, cellulose, cellulose derivates such as carboxymethylcellulose, cellulose ethers, methylcellulose, hydroxyethylcellulose or hydroxypropylcellulose, agar, alginates, pectins, gelatin, carrageen, traganth, gum arabic, casein, polyacrylamide, poly(meth)acrylic acid derivates, polyethylene glycol, polyvinyl ethers, polyvinyl alcohols, polyamides or polyimines.

If thickeners (H) are used, they are preferably constituents of component (K2).

If the composition (K) of the invention does comprise thickeners (H), preferably in component (K2), the amounts involved are preferably 0.5 to 100 parts by weight, more preferably 1 to 30 parts by weight, based in each case on 100 parts by weight of all the compounds (A1a), (A1b), (A2a) and/or (A2b) used in the mixture (K).

The fumed silicas, aluminosilicates or clay minerals already described as fillers (C) may also possess a thickening effect. These fillers (C) may therefore also be used with the aim of thickening the components (K1) and/or (K2) of the invention.

Unreactive plasticizers (I) are preferably phthalic esters, adipic esters, benzoic esters, glycol esters, esters of saturated alkanediols, phosphoric esters, sulfonic esters, polyesters, polyethers, polystyrenes, polybutadienes, polyisobutylenes, paraffinic hydrocarbons or high molecular weight branched hydrocarbons.

Preference is given to using unreactive plasticizers (I) having molar masses, or average molar masses Mₙ in the case of polymeric plasticizers, of 200 to 20 000 g/mol, more preferably of 500 to 10 000 g/mol, more particularly of 900 to 8000 g/mol.

Unreactive plasticizers (I) here may be a constituent both of component (K1) and of component (K2). They may also be included in both components (K1) and (K2).

If the compositions (K) of the invention do comprise unreactive plasticizers (I), the amounts involved are preferably 1 to 200 parts by weight, more preferably 5 to 100 parts by weight, based in each case on 100 parts by weight of all the compounds (A1a), (A1b), (A2a) and/or (A2b) used in the mixture (K). In one preferred embodiment of the invention the compositions (K) of the invention contain no unreactive plasticizers (I).

Examples of solvents (J) are low molecular weight ethers, esters, ketones, aromatic and aliphatic and also optionally halogen-containing hydrocarbons and alcohols, the latter being preferred.

Solvents (J) here may be a constituent both of component (K1) and of component (K2). They may also be included in both components (K1) and (K2).

With preference no organic solvents (J) are added to the compositions (K) of the invention.

The additives (L) used optionally in the compositions of the invention may be any desired additives known to date that are typical of silane-crosslinking systems.

The additives (L) used optionally in the invention are preferably antioxidants, UV stabilizers, such as HALS compounds as they are called, fungicides and pigments. Components (K2) may also, moreover, comprise, as additives, emulsifiers, which improve the compatibility and/or emulsifiability of water and the rest of the constituents of this component. The emulsifiers in question may be either ionic or nonionic emulsifiers.

Additives (L) here may be a constituent both of component (K1) and of component (K2). They may also be included in both components, (K1) and (K2).

If the compositions (K) of the invention do comprise additives (L), the amounts involved are preferably 0.01 to 30 parts by weight, more preferably 0.1 to 10 parts by weight, based in each case on 100 parts by weight of all of the compounds (A1a), (A1b), (A2a) and/or (A2b) used in the mixture (K). The compositions (K) of the invention preferably do comprise additives (L).

The adjuvants (M) used optionally in the invention are preferably tetraalkoxysilanes, examples being tetraethoxysilane and/or the partial condensates thereof, reactive plasticizers, rheological additives or flame retardants.

Preferred reactive plasticizers (M) are compounds which contain alkyl chains having 6 to 40 carbon atoms and which possess a group that is reactive toward the compounds (A1) and (A2). Examples are isooctyltrimethoxysilane, isooctyltriethoxysilane, N-octyltrimethoxysilane, N-octyltriethoxysilane, decyltrimethoxysilane, decyltriethoxysilane, dodecyltrimethoxysilane, dodecyltriethoxysilane, tetradecyltrimethoxysilane, tetradecyltriethoxysilane, hexadecyltrimethoxysilane and also hexadecyltriethoxysilane.

The rheological additives (M) are preferably polyamide waxes, hydrogenated caster oils or stearates.

Flame retardants (M) used may be any typical flame retardants, of the kind typical of adhesive systems and sealant systems, more particularly halogenated compounds and derivatives, especially esters of phosphoric acid.

Adjuvants (M) here may be a constituent both of component (K1) and of component (K2). They may also be included in both components, (K1) and (K2).

If the compositions (K) of the invention do comprise one or more components (M), the amounts involved are in each case preferably 0.5 to 200 parts by weight, more preferably 1 to 100 parts by weight, more particularly 2 to 70 parts by weight, based in each case on 100 parts by weight of all the compounds (A1a), (A1b), (A2a) and/or (A2b) used in the mixture (K).

The compositions (K) of the invention are preferably compositions consisting of a component (K1) comprising
(A1) organosilicon compounds selected from compounds (A1a) and (A1b),
optionally (B) compounds containing basic nitrogen,
optionally (C) fillers,
optionally (D) silicone resins,
optionally (E) catalysts,
optionally (F) adhesion promoters,
optionally (G) water scavengers,
optionally (I) unreactive plasticizers,
optionally (J) organic solvents,
optionally (L) additives, and
optionally (M) adjuvants,
   and also of a component (K2) comprising, based in each case on 100 parts by weight of compounds (A1) in component (K1), at least 0.05 part by weight of water and also (A2) 10 to 1000 parts by weight of organosilicon compounds selected from compounds (A2a) and (A2b),
optionally (C) fillers,
optionally (D) silicone resins,
optionally (F) adhesion promoters,
optionally (H) thickeners,
optionally (I) unreactive plasticizers,
optionally (J) organic solvents,
optionally (L) additives, and
optionally (M) adjuvants.

The compositions (K) of the invention are more preferably compositions consisting of a component (K1) comprising
(A1) 100 parts by weight of organosilicon compounds selected from compounds (A1a) and (A1b),
(B) compounds containing basic nitrogen,
optionally (C) fillers,
optionally (D) silicone resins,
optionally (E) catalysts,
optionally (F) adhesion promoters,
optionally (G) water scavengers,
optionally (I) unreactive plasticizers,
optionally (J) organic solvents,
optionally (L) additives, and
optionally (M) adjuvants,
   and also of a component (K2) comprising, based in each case on 100 parts by weight of compounds (A1) in component (K1), at least 0.05 part by weight of water and also (A2) 20 to 500 parts by weight of organosilicon compounds selected from compounds (A2a) and (A2b),
optionally (C) fillers,
optionally (D) silicone resins,
optionally (F) adhesion promoters,
optionally (H) thickeners,
optionally (I) unreactive plasticizers,
optionally (J) organic solvents,
optionally (L) additives, and
optionally (M) adjuvants.

Component (K1) used in the invention preferably comprises no constituents other than the compounds (A1) and also optionally (B), (C), (D), (E), (F), (G), (H), (I), (J), (L), (M) and (A2a).

Component (K2) used in the invention preferably comprises no constituents other than the compounds (A2), water and also optionally (B), (C), (D), (E), (F), (G), (H), (I), (J), (L) and (M).

The compositions (K) of the invention preferably comprise no constituents other than the compounds (A1a), (A1b), (A2a), (A2b), (B), (C), (D), (E), (F), (G), (H), (I), (J), (L), (M) and water.

Each of the constituents used in the invention may comprise one kind of any such constituent or else a mixture of at least two kinds of a respective constituent.

Component (K1) used in the invention has viscosities of preferably 500 to 1 000 000 mPas, more preferably of 1000 to 500 000 mPas, more particularly 1000 to 20 000 mPas, in each case at 25° C.

Component (K2) used in the invention has viscosities of preferably 500 to 1 000 000 mPas, more preferably of 1000 to 500 000 mPas, more particularly 1000 to 20 000 mPas, in each case at 25° C.

The proportion of components (K1) and (K2) may in principle be selected arbitrarily, provided the above-required proportions are achieved between compounds (A1) in component (K1) and compounds (A2) and also water in component (K2). The proportions of (K1) to (K2) are preferably between 5:1 and 1:5, more preferably between 2:1 and 1:2, based in each case on the weight.

Components (K1) and (K2) of the invention may be produced in any desired, conventional way, such as, for instance, according to techniques and mixing methods of the kind customary in the production of moisture-curing compositions. The sequence in which the various constituents are mixed with one another may be varied arbitrarily.

A further subject of the present invention is a method for producing the compositions (K) of the invention by mixing together components (K1) and (K2) and also optionally further components, the individual components having been produced by separately mixing together all of the constituents of the respective components in any order.

This mixing may take place at room temperature and under the pressure of the surrounding atmosphere, in other words about 900 to 1100 hPa. If desired, this mixing may alternatively take place at higher temperatures, such as at temperatures in the range from 30 to 130° C. It is additionally possible to carry out mixing temporally or continually under reduced pressure, such as at an absolute pressure of 30 to 500 hPa, in order to remove volatile compounds and/or air.

The mixing of component (K1) in accordance with the invention takes place preferably in the absence of moisture.

The method of the invention may be carried out continuously or discontinuously.

The individual components of the composition of the invention are storage-stable premixes, which can then be mixed shortly before or else during processing, especially in situ.

The compositions (K) of the invention are crosslinked during and/or after contacting of the components (K1) and (K2) preferably at room temperature, with mechanical mixing being preferred. If desired, crosslinking may also take place at temperatures higher or lower than room temperature, e.g., at −5° to 15° C. or at 30° to 50° C.

The crosslinking is carried out preferably under a pressure of 100 to 1100 hPa, more particularly under the pressure of the surrounding atmosphere.

A further subject of the invention are shaped articles produced by crosslinking the compositions (K) of the invention.

The shaped articles of the invention may comprise any desired shaped articles, such as, for instance, gaskets, compression moldings, extruded profiles, coatings, impregnations, encapsulation, lenses, prisms, polygonal structures, laminate layers or adhesive layers.

The compositions (K) of the invention are used preferably as adhesives or sealants. They can be used for bonding any materials, such as, for example, wood, concrete, porous stones, paper, fabrics, leather, etc. In contrast to one-component compositions curing only through contact with atmospheric moisture, they are also suitable for bonding water-impervious materials, such as, for example, metals, glass, water-impermeable ceramics, nonporous stones, plastics, painted surfaces, etc. This is also the case when very deep adhesive seams or very thick layers of adhesive would make atmospheric moisture curing impossible or would at least slow it down massively. It is possible here to bond both similar and different materials to one another.

The compositions (K) of the invention may also be used for sealing any joints between the above-stated materials.

A further subject of the invention are methods for bonding or sealing substrates, wherein the components (K1) and (K2) used in the invention and also optionally further components are first mixed with one another and subsequently applied to the surface of at least one substrate, then this surface is contacted with the second substrate to be bonded, and the composition (K) of the invention is subsequently caused to crosslink.

A further subject of the invention are methods for producing coatings or encapsulations, wherein the components (K1) and (K2) used in the invention and also optionally further components are first mixed with one another and subsequently applied to at least one substrate and the composition (K) of the invention is subsequently caused to crosslink.

Examples thereof are encapsulating compositions for LEDs or other electronic components, the production of moldings, composite materials and shaped composite parts. Shaped composite parts refer here to a unitary molding comprising a composite material, which is assembled from a crosslinking product of the compositions of the invention and from at least one substrate in such a way that between the two parts there is a firm, durable bond.

An advantage of the compositions (K) of the invention is that they are easy to produce.

An advantage of the crosslinkable compositions (K) of the invention is that they are notable for very high storage stability of the individual components.

An advantage of the crosslinkable compositions of the invention is that, after the mixing of components (K1) and (K2) and also any further components, they exhibit a high crosslinking rate and cure right through even at high layer thicknesses and/or in deep adhesive joints between two substrates that are impervious to water and atmospheric moisture.

A further advantage of the crosslinkable compositions of the invention is that they display an excellent adhesion profile.

Furthermore, an advantage of the crosslinkable compositions of the invention is that they can be used to produce adhesives having high lap shear strength.

In the examples described hereinafter, all viscosity figures are based on a temperature of 25° C. Unless otherwise indicated, the examples below are carried out under the pressure of the surrounding atmosphere, in other words approximately of 1000 hPa, and at room temperature, in other words at approximately 23° C., or at a temperature which comes about when the reactants are combined at room temperature without additional heating or cooling, and also are carried out at a relative atmospheric humidity of approximately 50%. Furthermore, all figures for parts and percentages, unless otherwise indicated, refer to the weight.

### EXAMPLES

Production example 1-1: producing a component (K1) for a 2K adhesive formulation (K1-1) 172.4 g of a double-sidedly silane-terminated polypropylene glycol having an average molar mass (Mₙ) of 12 000 g/mol and end groups of the formula —O—C(═O)—NH—CH₂—SiCH₃(OCH₃)₂ (available commercially under the name GENIOSIL® STP-E10 from Wacker Chemie AG, Munich (DE)) are homogenized for 2 minutes at 200 rpm in a laboratory planetary mixer from PC-Laborsystem, equipped with two cross-armed mixers, at around 25° C. with 34.4 g of a single-sidedly silane-terminated polypropylene glycol having an average molar mass (Mₙ) of 5000 g/mol and end groups of the formula —O—C(═O)—NH—CH₂—SiCH₃(OCH₃)₂ (available commercially under the name GENIOSIL® XM20 from Wacker Chemie AG, Munich (DE)), 10.4 g of vinyltrimethoxysilane and 3.6 g of a stabilizer mixture (mixture of 20% Irganox® 1135 (CAS No. 125643-61-0), 40% Tinuvin® 571 (CAS No. 23328-53-2) and 40% Tinuvin® 765 (CAS No. 41556-26-7), available commercially under the name TINUVIN® B 75 from BASF SE, Germany).

Thereafter, 69.2 g of a stearic acid-coated calcium carbonate having a mean particle diameter (D50%) of around 2.0 □m (available commercially under the name Omyabond 520 from Omya, Cologne (DE)) and 103.6 g of a fatty acid-coated precipitated chalk having a mean particle diameter (D50%) of around 0.07 □m (available commercially under the name Hakuenka CCR S10 from Shiraishi Omya GmbH, Gummem (AT)) are blended with stirring for one minute at 600 rpm. Lastly 6.4 g of N-(2-aminoethyl)-3-aminopropylmethyldimethoxysilane are mixed in for 1 minute at 200 rpm. To conclude, homogenization and bubble-free stirring are carried out for 2 minutes at 600 rpm and for 1 minute at 200 rpm under a pressure of 100 mbar.

The completed component (K1-1) is transferred to a container with facility for airtight sealing.

Production example 2-1: producing a component (K2) for a 2K adhesive formulation (K2-1) 200.0 g of a single-sidedly silane-terminated polypropylene glycol having an average molar mass (Mₙ) of 5000 g/mol and end groups of the formula —O—C(═O)—NH—CH₂—SiCH₃(OCH₃)₂ (available commercially under the name GENIOSIL® XM20 from Wacker Chemie AG, Munich (DE)) are blended with stirring for one minute at 600 rpm in a laboratory planetary mixer from PC-Laborsystem, equipped with two cross-arm stirrers, at around 25° C. with 100.0 g of a stearic acid-coated calcium carbonate having a mean particle diameter (D50%) of around 2.0 □m (available commercially under the name Omyabond 520 from Omya, Cologne (DE)), 40.0 g of a fatty acid-coated precipitated chalk having a mean particle diameter (D50%) of around 0.07 □m (available commercially under the name Hakuenka CCR S10 from Shirai-shi Omya GmbH, Gummern (AT)) and 60 g of a thermally activated colloidal magnesium aluminum silicate (available commercially under the name Micro-sorb 300 LVM from BASF SE, Germany).

Thereafter, 10 g of water are mixed in for 1 minute at 200 rpm. To conclude, homogenization and bubble-free stirring are carried out for 2 minutes at 600 rpm and for 1 minute at 200 rpm under a pressure of 100 mbar.

The completed component (K2-1) is transferred to a container with facility for airtight sealing.

Production example 2-2: producing a component (K2) for a 2K adhesive formulation (K2-2) The procedure was exactly the same as for production example 2-1, but replacing the 200 g of GENIOSIL® XM20 with 200 g of a singly branched silane-terminated polypropylene glycol having end groups of the formula —O—(CH₂)₃—SiCH₃(OCH₃)₂ (available commercially under the name MS 303H from Kaneka, Japan).

Production example 2-3: producing a component (K2) for a 2K adhesive formulation (K2-3) The procedure was exactly the same as for production example 2-1, but replacing the 200 g of GENIOSIL® XM20 with 200 g of a linear silane-terminated polypropylene glycol having end groups of the formula —O—(CH₂)₃—SiCH₃(OCH₃)₂ (available commercially under the name SAX 750 from Kaneka, Japan).

Production example 2-4: producing a component (K2) for a 2K adhesive formulation (K2-4) The procedure was exactly the same as for production example 2-1, but replacing the 200 g of GENIOSIL® XM20 with 200 g of a mixture of a linear silane-terminated polypropylene glycol and of a silane-modified polyacrylate, both having silyl groups of the formula —O—(CH₂)₃—SiCH₃(OCH₃)₂ (available commercially under the name MAX 951 from Kaneka, Japan).

### Examples 1 to 4

60 g in each case of the completed component K1-1 are mixed homogeneously with 40 g in each case of the completed components K2-1 (example 1), K2-2 (example 2), K2-3 (example 3) and K2-4 (example 4), respectively. The properties of the four compositions obtained are then determined.

### Skin-Forming Time (SFT)

The skin-forming time is determined by applying the resultant two-componently crosslinking compositions, each in a layer 2 mm thick, to PE film and storing these assemblies under standard conditions (23° C. and 50% relative humidity). Testing for formation of a skin is performed once per minute in the course of curing. For this testing, a dry laboratory spatula is placed carefully onto the surface of the specimen and is drawn upward. If sample remains adhering on the spatula, a skin has not yet formed. If sample no longer remains adhering on the spatula, a skin has formed, and the time is recorded. The results are found in table 1.

### Mechanical Properties

The 2-componently crosslinking compositions were each coated out onto milled-out Teflon plaques to a depth of 2 mm and cured for 2 weeks at 23° C. and 50 relative humidity.

The Shore A hardness is determined according to DIN EN 53505.

The tensile strength is determined according to DIN EN 53504-S1.

The elongation at break is determined according to DIN EN 53504-S1.

The 100% modulus is determined according to DIN EN 53504-S1.

The results are found in table 1

TABLE 1

| Composition from example | 1 | 2 | 3 | 4 |
|---|---|---|---|---|
| Component (K1) | (K1-1) | (K1-1) | (K1-1) | (K1-1) |
| Component (K2) | (K2-1) | (K2-2) | (K2-3) | (K2-4) |
| Mixing ratio | 60:40 | 60:40 | 60:40 | 60:40 |
| SFT [min] | 70 | 85 | 124 | 100 |
| Shore A hardness | 30 | 44 | 48 | 47 |
| Tensile strength [N/mm²] | 1.8 | 2.4 | 2.3 | 2.0 |
| Elongation at break [%] | 366 | 237 | 211 | 204 |
| 100% modulus [MPa] | 0.7 | 1.3 | 1.3 | 1.3 |

Production example 1-5: producing a component (K1) for a 2K adhesive formulation (K1-5) 91 g of a single-sidedly silane-terminated polypropylene glycol having an average molar mass (Mₙ) of 5000 g/mol and end groups of the formula —O—C(═O)—NH—CH₂—SiCH₃(OCH₃)₃ (available commercially under the name GENIOSIL® XM25 from Wacker Chemie AG, Munich (DE)) are homogenized for 2 minutes at 200 rpm in a laboratory planetary mixer from PC-Laborsystem, equipped with two cross-arm stirrers, at around 25° C. 4.5 g of vinyltrimethoxysilane and 1.5 g of a stabilizer mixture (mixture of 20% Irganox® 1135 (CAS No. 125643-61-0), 40% Tinuvin® 571 (CAS No. 23328-53-2) and 40% Tinuvin® 765 (CAS No. 41556-26-7), available commercially under the name TINUVIN® B 75 from BASF SE, Germany).

Thereafter, successively, 305 g of a spherical aluminum oxide (available commercially under the name Alunabeads™ CB A50 from Showa Denko, Tokyo (JP)), 375 g of a calcined aluminum oxide (available commercially under the name Alumina CL 3000 SG from Almatis, Ludwigshafen (DE)) and 220 g of zinc oxide (available commercially under the name Zinc Oxide Grade AZO 66 from U.S. Zinc, Houston (US)) are digested with stirring for one minute at 600 rpm. Lastly 3 g of N-(2-aminoethyl)-3-aminopropyltrimethoxysilane are mixed in for 1 minute at 200 rpm. To conclude, homogenization and bubble-free stirring are carried out for 2 minutes at 600 rpm and for 1 minute at 200 rpm under a pressure of 100 mbar.

The completed component (K1-5) is transferred to a container with facility for airtight sealing.

Production example 2-5: producing a component (K2) for a 2K adhesive formulation (K2-5) 96.2 g of a single-sidedly silane-terminated polypropylene glycol having an average molar mass (Mₙ) of 5000 g/mol and end groups of the formula —O—C(═O)—NH—CH₂—SiCH₃(OCH₃)₂ (available commercially under the name GENIOSIL® XM20 from Wacker Chemie AG, Munich (DE)) are blended with stirring for one minute at 600 rpm in a laboratory planetary mixer from PC-Laborsystem, equipped with two cross-arm stirrers, at around 25° C. with 305 g of a spherical aluminum oxide (available commercially under the name Alunabeads™ CB A50 from Showa Denko, Tokyo (JP)), 375 g of a calcined aluminum oxide (available commercially under the name Alumina CL 3000 SG from Almatis, Ludwigshafen (DE)) and 220 g of zinc oxide (available commercially under the name Zinc Oxide Grade AZO 66 from U.S. Zinc, Houston (US)). Subsequently, at a temperature of 55° C., 3.8 g of water homogenization and bubble-free stirring for 1 minute at 200 rpm under a pressure of 100 mbar.

The completed component (K2-5) is transferred to a container with facility for airtight sealing.

### Example 5

An adhesive based on components (K1-5) and (K2-5) is mixed in a mixing ratio of 1:1, based on the weight, in a Speedmixer and the mixture is left to cure for 2 weeks at 23° C. and 50 relative humidity. Subsequently, in a number of trials, the composition is applied between two aluminum plaques with an area of 700 mm² and measurements are made of the thermal conductivity according to ASTM 5470-12 at different gap thicknesses. A λ value of greater than 2.8 W/mK is ascertained.

1-13. (canceled)

14. A multicomponent crosslinkable composition (K) comprising at least one component (K1) and one component (K2), wherein component (K1) comprises organosilicon compounds (A1) selected from compounds (A1a) of the formula (Ia)
Y¹—[B¹—CR²₂—SiRₐ(OR¹)₃₋ₐ]ₓ (Ia)
and compounds (A1b) of the formula (Ib)
Y²—[B²—(CR⁴₂)_{b}—Si(OR³)₃]_{y} (Ib)
where
Y¹ is an x-valent polymer radical bonded via carbon,
Y² is a y-valent polymer radical bonded via carbon,
B¹ and B² each independently of one another may be identical or different and are a divalent linking group —O—, —NH—, —NR′—, —O—CO—NH—, —NH—CO—O—, —NH—CO—NH, —NH—CO—NR′—, —NR′—CO—NH—, —NH—CO—, —CO—NH—, —CO—O—, —O—CO—, —O—CO—O—, —S—CO—NH—, —NH—CO—S—, —CO—S—, —S—CO— or —S—,
R′ may be identical or different and is a monovalent, optionally substituted hydrocarbon radical or a group —CH(COOR*)—CH₂—COOR*, where R* is an alkyl radical,
R may be identical or different and is a monovalent, optionally substituted, SiC-bonded hydrocarbon radical,
R¹ and R³ each independently of one another may be identical or different and are the hydrogen atom or a monovalent, optionally substituted hydrocarbon radical,
R² and R⁴ each independently of one another may be identical or different and are the hydrogen atom or a monovalent, optionally substituted hydrocarbon radical which may be attached to the carbon atom via nitrogen, phosphorus, oxygen, sulfur or carbonyl group,
x and y each independently of one another are an integer from 1 to 10,
a may be identical or different and is 0, 1 or 2, with the proviso that if x=1 a=0,
b may be identical or different and is an integer from 3 to 10,
and component (K2), based in each case on 100 parts by weight of compounds (A1) in component (K1), comprises at least 0.05 part by weight of water and also 10 to 1000 parts by weight of a component (A2) selected from compounds (A2a) of the formula (IIa)
Y³—B³—CR⁷₂—SiR⁵_{c}(OR⁶)_{3-c} (IIa)
and compounds (A2b) of the formula (IIb)
Y⁴—[B⁴—(CR¹⁰₂)ₑ—SiR⁸_{d}(OR⁹)_{3-d}] (IIb)
where
Y³ is a monovalent polymer radical bonded via carbon,
Y⁴ is a z-valent polymer radical bonded via carbon,
B³ and B⁴ in each case independently of one another may be identical or different and are a divalent linking group —O—, —NH—, —NR″—, —O—CO—NH—, —NH—CO—O—, —NH—CO—NH, —NH—CO—NR″—, —NR″—CO—NH—, —NH—CO—, —CO—NH—, —CO—O—, —O—CO—, —O—CO—O—, —S—CO—NH—, —NH—CO—S—, —CO—S—, —S—CO— or —S—,
R″ may be identical or different and is a monovalent, optionally substituted hydrocarbon radical or a group —CH(COOR*)—CH₂—COOR*, where R* is an alkyl radical,
R⁵ and R⁸ each independently of one another may be identical or different and are a monovalent, optionally substituted, SiC-bonded hydrocarbon radical,
R⁶ and R⁹ each independently of one another may be identical or different and are the hydrogen atom or a monovalent, optionally substituted hydrocarbon radical,
R⁷ and R¹⁰ each independently of one another may be identical or different and are the hydrogen atom or a monovalent, optionally substituted hydrocarbon radical which may be attached to the carbon atom via nitrogen, phosphorus, oxygen, sulfur or carbonyl group,
z is an integer from 1 to 10,
c is 1 or 2,
d may be identical or different and is 1 or 2, and
e may be identical or different and is an integer from 3 to 10.

15. The crosslinkable composition of claim 14, wherein the composition is a two-component composition consisting of components (K1) and (K2).

16. The crosslinkable composition of claim 14, wherein component (A1) comprises compounds (A1a) and component (A2) comprises compounds (A2b).

17. The crosslinkable composition of claim 14, wherein the polymer radicals Y¹, Y², Y³ and Y⁴ independently of one another have no groups that are reactive with water or moisture.

18. The crosslinkable composition of claim 14, wherein the composition comprises organosilicon compounds (B) containing basic nitrogen.

19. The crosslinkable composition of claim 14, wherein, if the composition comprises tin catalysts (E), the amounts involved are such that the weight fraction of tin is at most 500 ppm by weight, based on the total weight of the composition (K).

20. The crosslinkable composition of claim 14, wherein the composition is tin-free.

21. The crosslinkable composition of claim 14, wherein the composition is of the kind consisting of a component (K1) comprising
(A1) organosilicon compounds selected from compounds (A1a) and (A1b),
optionally (B) compounds containing basic nitrogen,
optionally (C) fillers,
optionally (D) silicone resins,
optionally (E) catalysts,
optionally (F) adhesion promoters,
optionally (G) water scavengers,
optionally (I) unreactive plasticizers,
optionally (J) organic solvents,
optionally (L) additives, and
optionally (M) adjuvants,
and also of a component (K2) comprising, based in each case on 100 parts by weight of compounds (A1) in component (K1), at least 0.05 part by weight of water and also (A2) 10 to 1000 parts by weight of organosilicon compounds selected from compounds (A2a) and (A2b),
optionally (C) fillers,
optionally (D) silicone resins,
optionally (F) adhesion promoters,
optionally (H) thickeners,
optionally (I) unreactive plasticizers,
optionally (J) organic solvents,
optionally (L) additives, and
optionally (M) adjuvants.

22. The crosslinkable composition of claim 14, wherein the proportions of (K1) to (K2) are between 5:1 and 1:5, based on the weight.

23. A method for producing a composition as claimed in claim 14 by mixing together components (K1) and (K2) and also optionally further components, the individual components having been produced by separately mixing together all of the constituents of the respective components in any order.

24. A shaped article produced by crosslinking a composition as claimed in claim 14.

25. A shaped article produced by crosslinking a composition as claimed in claim 23.

26. A method for bonding or sealing substrates, wherein components (K1) and (K2) and also optionally further components are first mixed with one another and subsequently applied to the surface of at least one substrate, then this surface is contacted with the second substrate to be bonded, and the composition as claimed in claim 14 is subsequently caused to crosslink.

27. A method for bonding or sealing substrates, wherein components (K1) and (K2) and also optionally further components are first mixed with one another and subsequently applied to the surface of at least one substrate, then this surface is contacted with the second substrate to be bonded, and the composition is produced as claimed in claim 23 and is subsequently caused to crosslink.

28. A method for producing coatings or encapsulations, wherein components (K1) and (K2) and also optionally further components are first mixed with one another and subsequently applied to at least one substrate and the composition as claimed in claim 14 is subsequently caused to crosslink.

29. A method for producing coatings or encapsulations, wherein components (K1) and (K2) and also optionally further components are first mixed with one another and subsequently applied to at least one substrate and the composition is produced as claimed in claim 23 and is subsequently caused to crosslink.
